(19) United States
(12) Patent Application Publication
(10) Pub. No.: US 2004/0038581 A1
(43) Pub. Date: Feb. 26, 2004

(54) Plug-securing device

(76) Inventor: Jason Aaron Brown, Clinton, TN (US)

Correspondence Address: MICHAEL E. McKEE, Attorney at Law, 804 Swaps Lane, Knoxville, TN, 37923, US

(21) Appl. No.: 10/644,315

(22) Filed: Aug. 20, 2003

Related U.S. Application Data
(60) Provisional application No. 60/405,842, filed on Aug. 26, 2002.

(51) Int. Cl. H01R 13/62

(52) U.S. Cl. 439/373

(57) ABSTRACT

A device for securing a plug of a power cord within an electrical outlet includes a securement strap which is securable about the plug of a cord and elastomeric tensioning cords which are connected to the strap and which are securable to the plug into which the plug is to be plugged. The device, by way of the tensioning cords, resists the removal of the plug from the outlet, and is particularly well-suited for use in a marine environment for securing an electrical power cord which extends from a moored boat within an electrical outlet as the boat is moored adjacent the electrical outlet or for securing a plug of a power cord which extends from a dock to the electrical outlet of a boat moored at the dock.

The benefit of Provisional Application Ser. No. 60/405,842, filed Aug. 26, 2002 and entitled PLUG-SECURING DEVICE, is hereby claimed. The disclosure of this referenced provisional application is incorporated herein by reference.

### BACKGROUND OF THE INVENTION

This invention relates generally to marine accessories and relates, more particularly, to a device for releasably securing an electrical power cord which extends between a moored boat and a dock at which the boat is moored to either an electrical outlet on the boat or to an electrical outlet at the dock.

As a boat remains moored in a boat dock or the like, it is common that an electrical power cord extending from the boat is plugged into an electrical outlet at the dock for providing electrical power to power-consuming appliances on the boat. For the same reason, it is also common that an electrical power cord which extends from the dock is plugged into an electrical outlet on the boat. Heretofore, however, the plug of the power cord is susceptible of coming unplugged from either the electrical outlet at the dock or the electrical outlet on the boat as the boat is permitted to rock back and forth in the water.

It would be desirable to provide a means for preventing the plug of the power cord which is utilized in such a marine application from the boat from coming unplugged from an electrical outlet while the boat remains moored.

Accordingly, it is an object of the present invention to provide a new and improved device for securing a plug of a power cord within an electrical outlet.

Another object of the present invention is to provide such a device which is particularly well-suited for use in a marine environment to secure the plug of a power cord which extends from a moored boat within an electrical outlet situated adjacent the boat or to secure the plug of a power cord which extends from a dock within an electrical outlet on a boat moored adjacent the dock.

Still another object of the present invention is to provide such a device which is uncomplicated in construction yet effective in operation.

### SUMMARY OF THE INVENTION

This invention resides in a device for securing a plug of a power cord within an electrical outlet.

The device includes a securement strap which is securable about the plug of a cord and a tensioning cord which is connected to the strap and which is securable to the electrical outlet into which the plug is to be plugged. The device, by way of the tensioning cord, resists the removal of the plug from the outlet.

### BRIEF DESCRIPTION OF THE DRAWINGS

FIG. 1 is an elevational view of one embodiment of the device, shown in a spread condition.

FIG. 2 is a perspective view of an illustrative environment, including electrical cord plug and outlet, within which the embodiment of FIG. 1 can be used.

FIG. 3 is a perspective view of the embodiment of FIG. 1, shown in a partially-wrapped condition.

FIG. 4 is a perspective view of the FIG. 1 embodiment shown wrapped about the plug of FIG. 2.

FIGS. 5 and 6 are perspective views of the FIG. 1 embodiment used in the environment of FIG. 2 and showing alternative ways in which the plug of FIG. 2 can be secured within the outlet of FIG. 2 with the FIG. 1 device.

FIG. 7 is a perspective view, similar to that of FIGS. 5 and 6, illustrating another embodiment of the device being used to secure a plug within an electrical outlet.

### DETAILED DESCRIPTION OF THE ILLUSTRATED EMBODIMENT

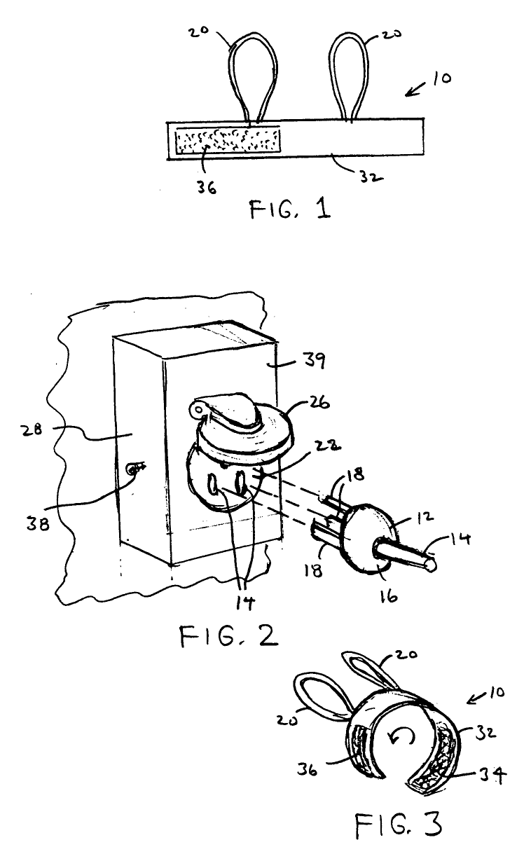

Turning now to the drawings in greater detail and considering first FIG. 1, there is shown an embodiment of a device, generally indicated 10, for securing a plug of an extension cord within an electrical outlet, or receptacle. As best shown in FIG. 2, the plug, indicated 12, of an electrical power cord 14 includes a body 16 from which electrical prongs 18 extend, and the electrical outlet 22 commonly includes a plurality of recesses, or openings 24, for accepting the prongs 18 of the plug 12. In addition, the outlet 22 can include a cover 26 or other stationary item (such as screws 38 or a flat surface 28 disposed alongside the outlet openings 24) situated adjacent the outlet 22. As will be apparent herein, the device 10 cooperates with the stationary item situated adjacent the outlet 22 to secure the plug 12 within the outlet 22.

With reference to FIGS. 1 and 3, the device 10 includes a securement strap 32 which is releasably securable about the body 16 (FIG. 2) of an electrical plug 12. The strap 32 (FIGS. 1 and 3) is flexible in nature and includes cooperating hook and loop-type fastener members 34 and 36, respectively, (such as are available under the trade designation VELCRO) adjacent the ends thereof so that when the strap 32 is positioned about the plug body 16 and the ends of the strap 32 are pressed together, the strap 32 is secured about the plug body 16 by way of the fastener members 34, 36. The strap 36 of the depicted device 10 is comprised of a fabric material, but other materials, such as a plastic material, can be used.

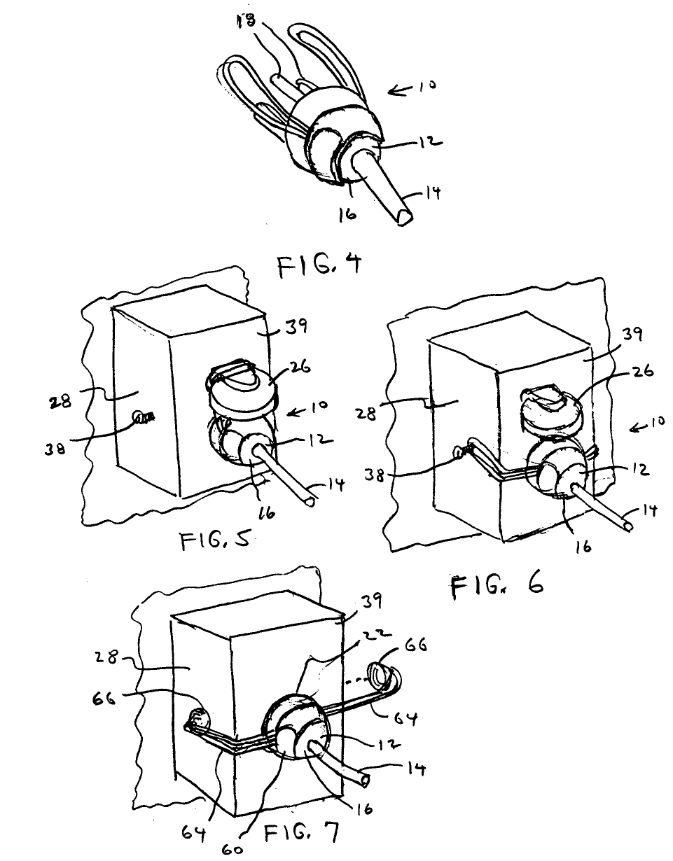

The device 10 further includes two tensioning cords 20 which are connected to the strap 32 and which are securable to or about a stationary support item situated adjacent the electrical outlet into which the plug 16 is to be plugged. To this end, each tensioning cord 20 is in the form of a string which is attached (e.g. sewn into the material of the strap 32) at each end thereof and to one side of the strap 32 to form loops thereat. Moreover, each cord 20 is secured along the length of the strap 32 so that when the strap 32 is secured about a plug body 16 (as illustrated in FIG. 4), the cords 20 (and more particularly, the loops formed ther by) are disposed on diametrically-opposed sides of the plug body 16.

It is a feature of the present invention that at least one of the components (i.e. either the strap 32 or the tensioning cords 20) can include an elastomeric material which renders the components capable of being stretched from a relaxed to an extended condition. When the strap 32 is secured about the plug body 16 and the cords 20 are secured about the stationary item situated adjacent the outlet, it is preferred that the elastomeric material-including component (i.e. either the strap 32 or the cords 20) be placed in a stretched condition. This way, the elastomeric nature (i.e. the tendency of the elastomeric component to return to its relaxed condition) of the stretched component biases the plug body 16 into its corresponding outlet and thereby resists the withdrawal of the plug body 16 from the outlet 22. Within the depicted device 10, it is the tensioning cords 20 which include an elastomeric material.

The loops formed by the cords 20 are of identical size and are adapted to be secured to or about a stationary an item situated adjacent the electrical outlet 22. Such an item can be comprised, for example, of the aforementioned cover 26 (FIG. 2) for the outlet 22, exposed screws 38 (FIG. 2) situated on the sides of a box 39 which may house the electrical outlet 22, or the box 38 itself. In any event, to secure the device 10 about the item, the loops formed by the cords 20, 20 are simply looped, so as to be hooked, about the item or wrapped about the item. With the securement straps 32 secured about the plug body 16 and the cords 20 secured to, or looped or wrapped about, the adjacent item, the removal of the plug 12 from the electrical outlet 22 is resisted by the device 10.

By way of example, there is illustrated in FIG. 5 the device 10 shown with its cords 20 looped about the cover 26 of the electrical outlet 22, and there is illustrated in FIG. 6 the device 10 shown with its cords 20 looped about the exposed screws 38 (only one shown) situated on opposite sides of the electrical outlet 22.

The device 10 can be used for securing an electrical plug which extends from a boat within an electrical outlet situated adjacent the location at which the boat is moored. Similarly, the device 10 can be used for securing the electrical plug which extends from a dock within an electrical outlet on the boat. However, other uses of the device can be had wherein an electrical plug is desired to be secured in an electrical outlet. Accordingly, the principles of the invention can be variously applied.

It will be understood that numerous modifications and substitutions can be had to the aforedescribed embodiments without departing from the spirit of the invention. For example, although the cords 20 of the device 10 of FIGS. 1 and 3 have been shown and described as being securable to an item situated adjacent the electrical outlet over which the loops formed by the cords 20 can be looped, a device in accordance with the broader aspects of the invention can include other components which are attached to the loops, such as suction cups, which enable the device to be secured to a flat surface, or wall, disposed adjacent the electrical outlet. For example, there is illustrated in FIG. 7 a device 60 having a strap 62 and elastomeric tensioning cords 64 to which attached a pair of suction cups 66 which are attachable to a smooth, flat surface 28 situated alongside the outlet within which the plug 12 is secured. Accordingly, the aforedescribed embodiment is intended for the purpose of illustration and not as limitation.

1. A device for securing a plug of a power cord within an electrical outlet, the device comprising:
a securement strap which is securable about the plug of a cord; and
a tensioning cord which is connected to the strap and which is securable to the electrical outlet within which the plug is to be plugged so that removal of the plug from the electrical outlet is resisted by the tensioning cord.

2. The device as defined in claim 1 wherein the securement strap includes an elongated strip of flexible material adapted to be wrapped about the body of a plug and means associated with the elongated strip for releasably securing the elongated strip in a wrapped condition about the body of the plug.

3. The device as defined in claim 2 wherein the means for releasably securing includes hook and loop fastener members which are attached to the elongated strip for releasably securing the elongated strip about the body of the plug.

4. The device as defined in claim 1 wherein the tensioning cord is connected to the securement strap to form a loop which is capable of being secured to the electrical outlet.

5. The device as defined in claim 4 wherein the tensioning cord is a first tensioning cord and the device further includes a second tensioning cord which is connected to the strap and which is securable to the electrical outlet within which the plug is to be plugged.

6. The device as defined in claim 5 wherein the first and second tensioning cords are connected to the securement strap at locations therealong so that when the securement strap is secured about the plug of an electrical cord, the first and second tensioning cords are disposed on diametrically-opposed sides of the plug.

7. The device as defined in claim 4 further including a suction cup which is attached to the tensioning cord for attachment of the tensioning cord to a flat surface situated adjacent the electrical outlet by way of the suction cup.

8. The device as defined in claim 1 wherein there is associated with the electrical outlet a stationary item disposed adjacent the electrical outlet, and the tensioning cord is securable to the stationary item to thereby connect the tensioning cord to the electrical outlet.

9. The device as defined in claim 1 wherein one of the securement strap and the tensioning cord is elastomeric.

10. A device for securing a plug of a power cord within an electrical outlet wherein a stationary item is disposed adjacent the electrical outlet, the device comprising:
a securement strap which is securable about the plug of a cord, the securement strap including an elongated strip of flexible material which is capable of being wrapped about the body of the plug when secured thereabout; and
at least one elastomeric tensioning cord which is connected to the strap and which is securable about the stationary item situated adjacent the electrical outlet into which the plug is to be plugged so that removal of the plug from the electrical outlet is resisted by the at least one tensioning cord.

11. The device as defined in claim 10 wherein the securement strap includes a flexible fabric material, and the device further includes means associated with the elongated strip for releasably securing the elongated strip in a wrapped condition about the body of the plug.

12. The device as defined in claim 11 wherein the means for releasably securing includes hook and loop fastener members which are attached to the elongated strip for releasably securing the elongated strip about the body of the plug.

13. The device as defined in claim 10 wherein the at least one tensioning cord is connected to the securement strap to form a loop which is capable of being secured to the electrical outlet.

14. The device as defined in claim 10 wherein there are two tensioning cords which are connected to the securement strap.

15. The device as defined in claim 14 wherein the two tensioning cords are connected to the securement strap at locations therealong so that when the securement strap is secured about the plug of an electrical cord, the tensioning cords are disposed on diametrically-opposed sides of the plug.

16. The device as defined in claim 15 further including a suction cup which is attached to each of the elastomeric tensioning cords for attachment of each cord to a flat surface situated adjacent the electrical outlet by way of the suction cup.

17. The device as defined in claim 10 wherein there is associated with the electrical outlet a stationary item disposed adjacent the electrical outlet, and the at least one tensioning cord is securable to the stationary item to thereby connect the at least one tensioning cord to the electrical outlet.

18. The device as defined in claim 1 wherein the at least one tensioning cord is elastomeric.

19. A device for securing a plug of a power cord within an electrical outlet, the device comprising:
a securement strap which is securable about the plug of a cord wherein the strap includes an elongated strip of flexible material and means for releasably securing the elongated strip of flexible material in a wrapped condition about the plug; and
a pair of elastomeric tensioning cords which are connected to the strap and which are securable to the electrical outlet within which the plug is to be plugged so that removal of the plug from the electrical outlet is resisted by the tensioning cords; and
wherein each of the tensioning cords is connected to the securement strap to form a loop which facilitates the securement of the tensioning cords to the electrical outlet.
